(19) United States
(12) Patent Application Publication
(10) Pub. No.: US 2006/0244927 A1
(43) Pub. Date: Nov. 2, 2006

(54) Heat dissipating structure for use in projector

(75) Inventors: Jung-Chi Chen, Miao Li County (TW); Tsan-Fu Tseng, Taipei Hsien (TW); Che-Hsueh Chen, Miao Li County (TW); Chi-Yu Meng, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/409,960

(22) Filed: Apr. 25, 2006

(30) Foreign Application Priority Data
Apr. 29, 2005 (TW) 94114044

(51) Int. Cl. G03B 21/18

(52) U.S. Cl. 353/55

(57) ABSTRACT

A projector includes a casing having a front wall formed with a first opening and a second opening. A heat dissipating structure includes a plurality of elongated fins mounted vertically within the second opening in the casing, a connecting rod disposed in the second opening to extend in a horizontal direction and fastened operably to the fins in such a manner that a horizontal movement of the connecting rod in the second opening results in a tilt angle of the fins with respect to the front wall of the casing, and a push rod fixed to one of the fins and projecting outwardly from the casing via the second opening. The push rod can be manually manipulated in the leftwise or rightwise direction of the casing to result in a change of the tilt angle of the fins relative to the front wall of the casing.

### FIELD OF THE INVENTION

The invention relates to a heat dissipating structure, and more particularly to a heat dissipating structure for use in a projector to dissipate heat generated during operation therefrom.

### BACKGROUND OF THE INVENTION

A projection lens is disposed in a conventional projector in order to project an image onto a screen with a light beam emitted by a light bulb.

Referring to FIG. 1, a conventional projector 2 includes an outer casing 4 and a heat dissipating device 11 disposed in the outer casing 4 for dissipating the heat generated due to an operation of the conventional projector. The heat dissipating device 11 generally includes an air inlet (not shown), a fan 12 disposed in the outer casing 4, and a heat guiding structure 14 mounted on the outer casing 4 at a front portion thereof in front of the fan 12. The outer casing 4 has a front wall formed with first and second openings 6, 8. The projection lens 10 is mounted in the first opening 6 in the front wall of the outer casing 4 to project an image onto the screen via the front opening 6. The heat guiding structure 14 is mounted in the second opening 8 in the front wall of the outer casing 4 for guiding heat from an interior to an exterior of the outer casing 4.

Referring to FIG. 2, the heat guiding structure 14 includes a plurality of elongated fins 1402 mounted vertically within the second opening 8 in the outer casing 4 such that the heat is guided out in a D1 direction. As illustrated in FIG. 3, when the conventional projector 2 is used within an auditorium and the heat is guided out toward a right side direction of the outer casing 4 due to the air circulation A of the ventilation system coming from the left side of the auditorium. The audience seated at a right side of the outer casing 4 may feel uncomfortable due to the heat flow. Referring to FIG. 4, when the heat is guided out toward a left side direction of the outer casing 4 due to the air circulation A of the ventilation system coming from the right side of the auditorium, the heat flow may result in unstable projection of image onto the screen such that the projected image in the screen trembles with vibration.

### SUMMARY OF THE INVENTION

The object of the present invention is to provide a projector having a heat dissipating structure that is adapted to guide heat from an interior of an outer casing of the projector into a desired direction, thereby overcoming the disadvantage encountered during use of the conventional projector.

In one aspect of the present invention, a heat dissipating structure is provided for use in a projector. The projector includes an outer casing having a front wall formed with a first opening and a second opening, and a projection lens mounted in first opening of the outer casing to project an image onto a screen, the second opening being defined by an opening-confining wall having opposite upper and lower wall portions formed with a plurality of pivot holes. The heat dissipating structure is mounted in the second opening and includes a plurality of elongated fins for mounted vertically within the second opening in the front wall of the outer casing, each of the elongated fins having opposite upper and lower portions respectively formed with upper and lower pivot pins that are adapted to extend into the respective pivot holes in the upper and lower wall portions of the second opening in the front wall of the outer casing such that the elongated fins extend vertically in the second opening; a connecting rod adapted to be disposed in the second opening to extend in a horizontal direction and fastened operably to the elongated fins in such a manner that a horizontal movement of the connecting rod in the second opening results in a tilt angle of the elongated fins with respect to the front wall of the outer casing; and a push rod fixed to one of the elongated fins and protruding outwardly from the outer casing via the second opening. The push rod is pushed in leftwise or rightwise of the outer casing so as to result in the tilt angle of the elongated fins with respect to the front wall of the outer casing due to simultaneous rotation of the elongated fins and by virtue of the connecting rod.

In a second aspect of the present invention, a projector is provided to include an outer casing having a front wall formed with a first opening and a second opening, the second opening being defined by an opening-confining wall having opposite upper and lower wall portions formed with a plurality of pivot holes; a projection lens disposed in the outer casing to project an image onto a screen; and a heat dissipating structure. The heat dissipating structure includes a plurality of elongated fins mounted vertically within the second opening in the outer casing, each of the elongated fins having opposite upper and lower portions respectively formed with upper and lower pivot pins that extend into respective pivot holes in the upper and lower portions of the second opening in the outer casing such that the elongated fins extend vertically in the second opening in the outer casing. The elongated fins are pushed in leftwise or rightwise of the outer casing so as to form a tilt angle of the elongated fins with respect to the front wall of the outer casing.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a conventional projector;

FIG. 2 is a top fragmentary sectional view illustrating the elongated fins of the heat dissipating structure of the conventional projector;

FIG. 3 is a top fragmentary sectional view showing the elongated fins of the heat dissipating structure of the conventional projector dissipate heat in a first direction;

FIG. 4 is a top fragmentary sectional view showing the elongated fins of the heat dissipating structure of the conventional projector dissipate heat in a second direction opposite to the first direction;

FIG. 5 is a top fragmentary sectional view of the embodiment of a projector of the present invention;

FIG. 6 is a perspective view of the embodiment of the projector of the present invention;

FIG. 7 illustrates a partly exploded view of a heat dissipating structure employed in the embodiment of the projector of the present invention;

FIG. 8 illustrates a partly exploded view of a modified heat dissipating structure employed in the embodiment of the projector of the present invention;

FIG. 9 is a top fragmentary sectional view illustrating the elongated fins of the heat dissipating structure of the projector of the present invention dissipating heat in a first direction; and

FIG. 10 is a top fragmentary sectional view illustrating the elongated fins of the heat dissipating structure of the projector of the present invention dissipating heat in a second direction different from the first direction.

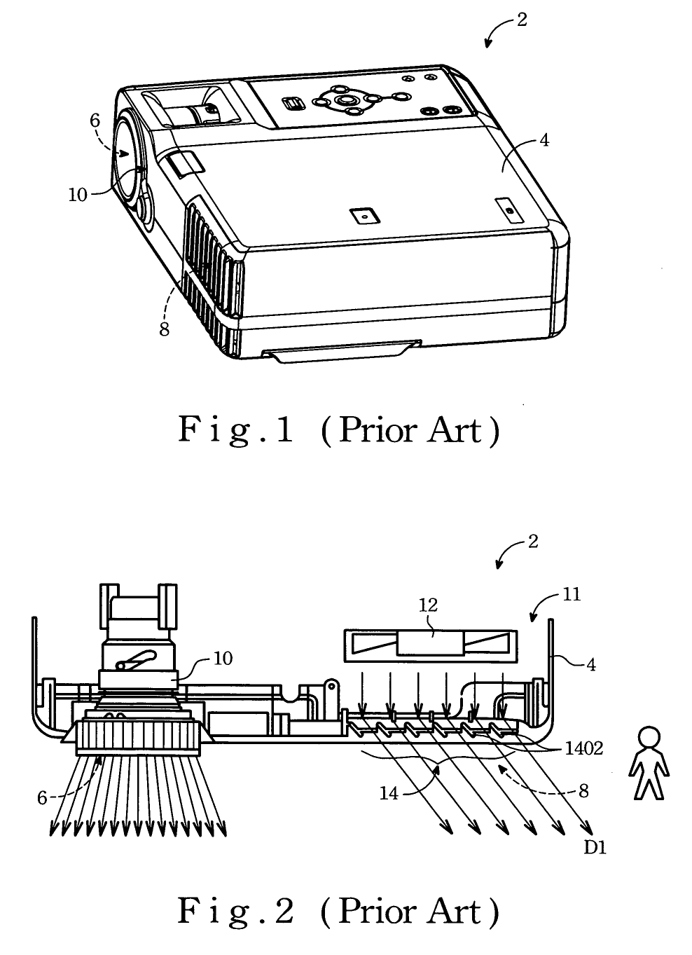

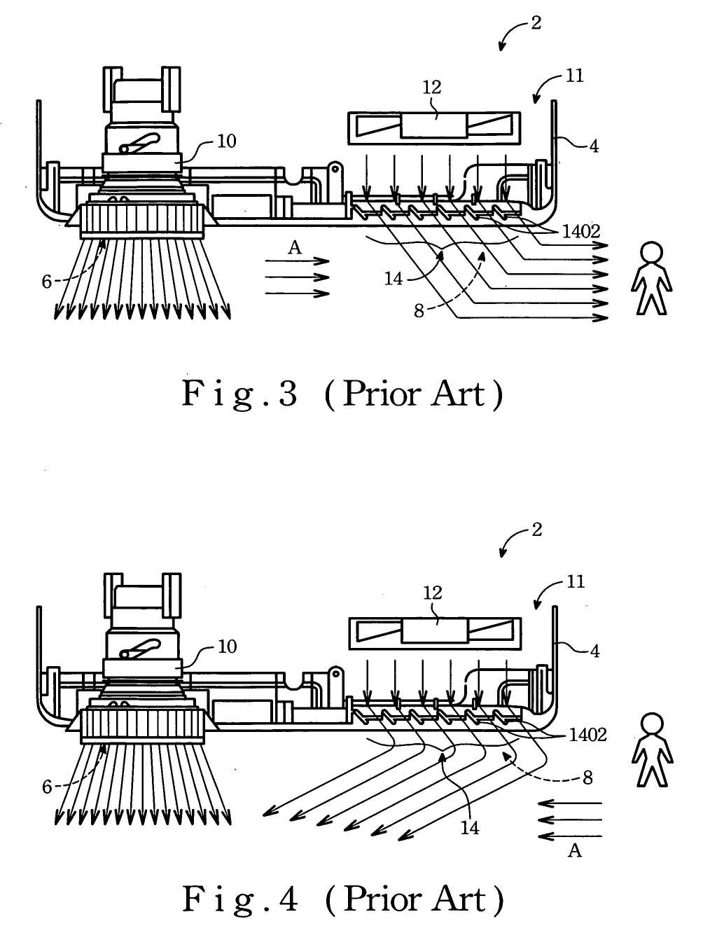

### DETAILED DESCRIPTION OF THE PREFERRED EMBODIMENTS

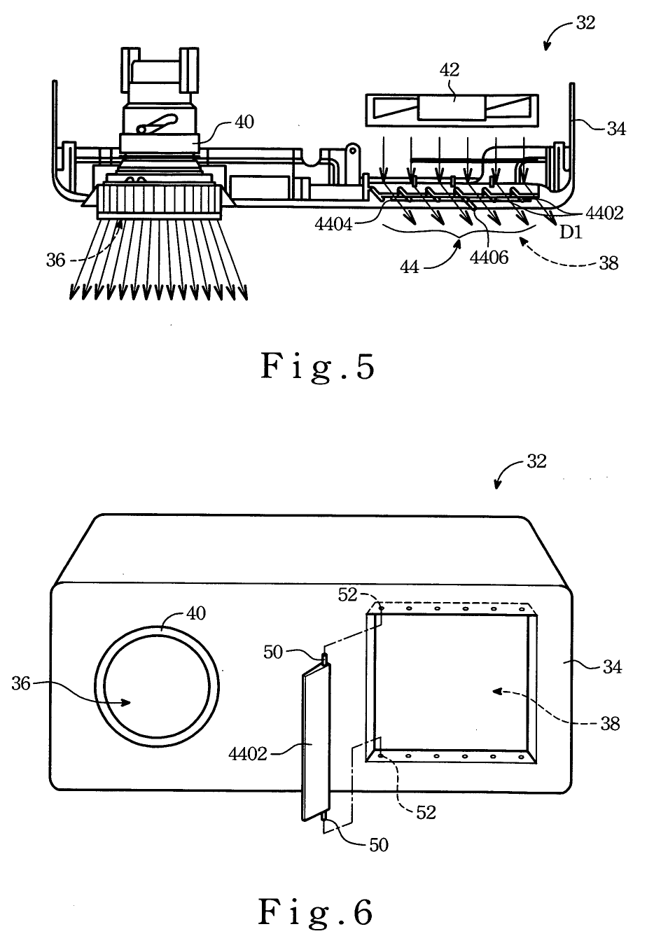

Refer to FIGS. 5 and 6, a projector 32 of the present invention includes an outer casing 34, a projection lens 40, a fan 42 and a heat dissipating structure 44.

As illustrated, the outer casing 34 has a front wall formed with a first opening 36 and a second opening 38. The outer casing 34 further has opposite left and right sides. The first opening 36 is disposed adjacent to the left side of the outer casing 34. The second opening 38 is disposed adjacent to the right side of the outer casing 34. The second opening 38 is defined by an opening-confining wall having opposite upper and lower wall portions formed with a plurality of pivot holes 52.

The projection lens 40 is disposed in the outer casing 34 behind the first opening 36 to project an image onto a screen. The fan 42 is disposed within the outer casing 34 behind the second opening 38 in the outer casing 34 to blow heat generated due to an operation of the projector 32 outwardly from the outer casing 34 via the second opening 38.

The heat dissipating structure 44 includes a plurality of elongated fins 4402, a connecting rod 4404, and a push rod 4406. The elongated fins 4402 are mounted vertically within the second opening 38 in the outer casing 34. Each of the elongated fins 4402 has opposite upper and lower portions respectively formed with upper and lower pivot pins 50 that extend into respective pivot holes 52 in the upper and lower wall portions of the second opening 38 in the outer casing 34 such that the elongated fins 4402 extend vertically in the second opening 38 in the outer casing 34. The connecting rod 4404 is in the second opening 38 to extend in a horizontal direction and fastened operably to the upper portions of the elongated fins 4402 in such a manner that a horizontal movement of the connecting rod 4404 in the second opening 38 results in a tilt angle of the elongated fins 4402 with respect to the front wall of the outer casing 34. The push rod 4406 is fixed to one of the elongated fins 4402 and protrudes outwardly from the outer casing 34 via the second opening 38. The push rod 4406 can be pushed by a user in the leftwise or rightwise of the outer casing 34 so as to result in the tilt angle of the elongated fins 4402 with respect to the front wall of the outer casing 34 due to simultaneous rotation of the elongated fins 4402 such that the heat is guided out of the outer casing 34 in the D1 direction, as best shown in FIG. 5. Preferably, each of the upper and lower portions of a respective one of the elongated fins 4402 has opposite front and rear ends. The pivot pins 50 are respectively formed on the upper and lower portions of the respective one of the elongated fins 4402 respectively adjacent to the rear ends. Alternately, each of the upper and lower portions of the respective elongated fin 4402 further has an intermediate section between the front and rear ends thereof. The pivot pins 50 are respectively formed on the intermediate sections of the upper and lower portions of the respective one of the elongated fins 4402 (not shown).

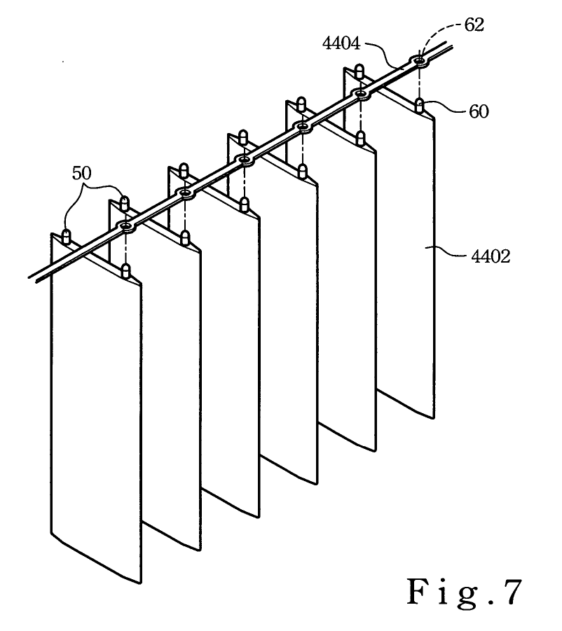

Referring to FIG. 7, in this embodiment, the connecting rod 4404 is formed with a plurality uniformly spaced apart pivot holes 62. The upper portion of each of the elongated fins 4402 further has an extra pivot pin 60 that is adjacent to the front end and that extends into a respective one of the pivot holes 62 in the connecting rod 4404, thereby interconnecting the elongated fins 4402 to one another to permit simultaneous rotation of the elongated fins 4402 within the second opening 38.

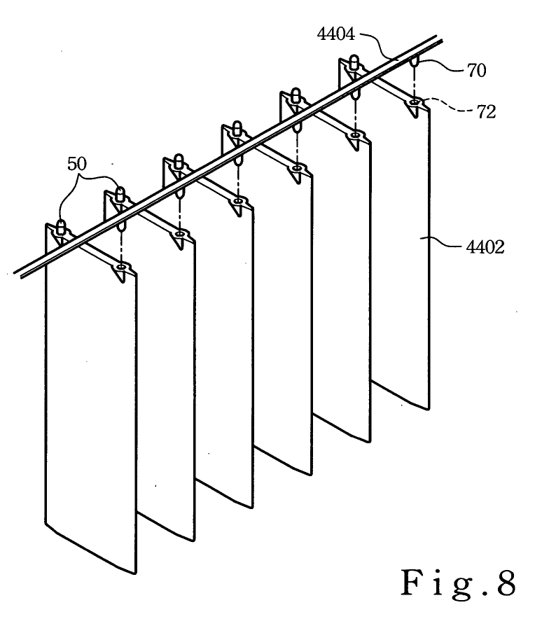

Referring to FIG. 8, in another embodiment, the upper portion of each of said elongated fins 4402 has a pivot hole 72 adjacent to the front end thereof. The connecting rod 4404 is disposed above the upper portions of the elongated fins 4402. The connecting rod 4404 is formed with a plurality of pivot pins 70 extending into the pivot holes 72 in the upper portions of the elongated fins 4402, thereby interconnecting the elongated fins 4402 to one another to permit simultaneous rotation of the elongated fins 4402 with respect to the front wall of the outer casing 34.

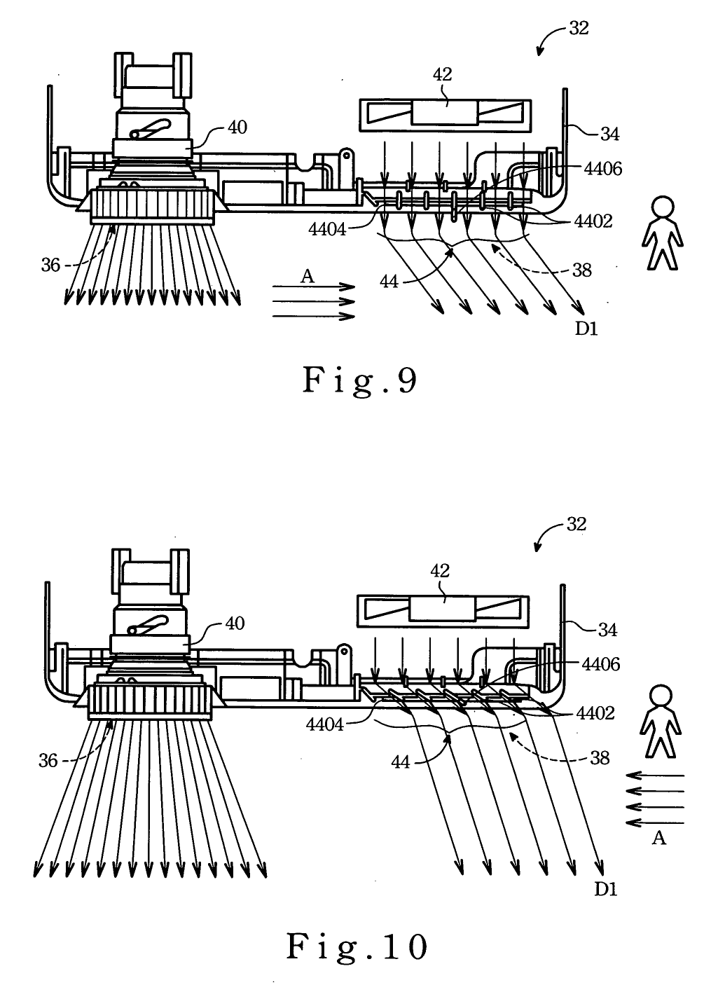

Referring to FIG. 9, in the event, the projector 32 of the present invention is used in a conference room for presenting a business plan or a construction project, the flow direction of the hot air generated due to operation of the projector 32 is put under the influence of the room ventilation system. As illustrated, in case the hot air is blown toward the right side of the outer casing 34 due to the air circulation A coming from the left side of the conference room (since the air vent is located at the left side) to cause uncomfortable feeling to the audience nearby. Under this condition, the tilt angle of the elongated fins 4402 with respect to the front wall of the outer casing 34 can be adjusted by pushing the push rod 4406 toward the leftwise direction, thereby causing a slight tilt of the elongated fins 4402 with respect to the front wall of the outer casing 34. Therefore, the flowing direction D1 is changed into a position between the audience and the projection lens 40.

Referring to FIG. 10, in the event the air circulation A of the room ventilation system causes the hot air to flow in the leftwise manner (since the air vent is located at the right side of the conference room) so as to result in unstable projection of image onto the screen such that the projected image in the screen trembles with vibration. Under such condition the tilt angle of the elongated fins 4402 with respect to the front wall of the outer casing 34 can be adjusted by pushing the push rod 4406 toward the rightwise direction, thereby causing a slight tilt of the elongated fins 4402 with respect to the front wall of the outer casing 34. Therefore, the flowing direction D1 is changed into a position between the audience and the projection lens 40.

To summarize the above paragraphs, it is observable that employment of the push rod 4406 onto the connecting rod 4404 so as to result in simultaneous rotation of the elongated fins 4402 with respect to the front wall of the outer casing, the heat within the outer casing 34 can be guided outward in the desired direction.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A heat dissipating structure for use in a projector, the projector including an outer casing having a front wall formed with a first opening and a second opening, and a projection lens mounted in the first opening of the outer casing to project an image onto a screen, the second opening being defined by an opening-confining wall having opposite upper and lower wall portions formed with a plurality of pivot holes, the heat dissipating structure being mounted in the second opening and comprising:
a plurality of elongated fins for mounting vertically within the second opening in the front wall of the outer casing, each of said elongated fins having opposite upper and lower portions respectively formed with upper and lower pivot pins that are adapted to extend into the respective pivot holes in the upper and lower wall portions of the second opening in the front wall of the outer casing such that said elongated fins extend vertically in the second opening;
a connecting rod adapted to be disposed in the second opening to extend in a horizontal direction and fastened operably to said elongated fins in such a manner that a horizontal movement of said connecting rod in the second opening results in a tilt angle of said elongated fins with respect to the front wall of the outer casing; and
a push rod fixed to one of said elongated fins and protruding outwardly from the outer casing via the second opening;
whereby, said push rod is pushed in leftwise or rightwise of the outer casing so as to result in said tilt angle of said elongated fins with respect to the front wall of the outer casing due to simultaneous rotation of said elongated fins and by virtue of said connecting rod.

2. The heat dissipating structure according to claim 1, wherein each of said upper and lower portions of a respective one of said elongated fins has opposite front and rear ends and an intermediate section between said front and rear ends, said pivot pins being respectively formed on said intermediate sections of said upper and lower portions of said respective one of said elongated fins.

3. The heat dissipating structure according to claim 1, wherein each of said upper and lower portions of a respective one of said elongated fins has opposite front and rear ends, said pivot pins being respectively formed on said upper and lower portions of said respective one of said elongated fins respectively adjacent to said rear ends.

4. The heat dissipating structure according to claim 1, wherein said upper portion of each of said elongated fins has opposite front and rear ends and a pivot hole adjacent to said front end thereof, said connecting rod being disposed above said upper portions of said elongated fins and formed with a plurality of pivot pins extending into said pivot holes in said upper portions of said elongated fins, thereby interconnecting said elongated fins to one another.

5. The heat dissipating structure according to claim 1, wherein said connecting rod is formed with a plurality uniformly spaced apart pivot holes, said upper portion of each of said elongated fins further having opposite front and rear ends and an extra pivot pin adjacent to said front end and extending into a respective one of said pivot holes in said connecting rod, thereby interconnecting said elongated fins to one another.

6. The heat dissipating structure according to claim 1, wherein the outer casing has opposite left and right sides, the first opening being disposed adjacent to the left side of the outer casing, the second opening being disposed adjacent to the right side of the outer casing.

7. The heat dissipating structure according to claim 1, further comprising a fan disposed in the outer casing behind the second opening in the front wall of the outer casing.

8. A projector comprising:
an outer casing having a front wall formed with a first opening and a second opening, said second opening being defined by an opening-confining wall having opposite upper and lower wall portions formed with a plurality of pivot holes;
a projection lens disposed in said outer casing to project an image onto a screen; and
a heat dissipating structure including
a plurality of elongated fins mounted vertically within said second opening in said outer casing, each of said elongated fins having opposite upper and lower portions respectively formed with upper and lower pivot pins that extend into respective pivot holes in said upper and lower wall portions of said second opening in said outer casing such that said elongated fins extend vertically within said second opening in said outer casing,
whereby, said elongated fins is pushed in leftwise or rightwise of said outer casing so as to form a tilt angle of said elongated fins with respect to said front wall of said outer casing.

9. The projector according to claim 8, wherein said heat dissipating structure further includes a connecting rod disposed in said second opening in said outer casing to extend in a horizontal direction and fastened operably to said elongated fins in such a manner that a horizontal movement of said connecting rod in said second opening results in said tilt angle of said elongated fins with respect to said front wall of said outer casing.

10. The projector according to claim 9, wherein said heat dissipating structure further includes a push rod fixed to one of said elongated fins and projecting outwardly from said outer casing via said second opening, whereby, said push rod can be manually pushed in said leftwise or rightwise of said outer casing so as to result in said tilt angle of said elongated fins with respect to said front wall of said outer casing due to simultaneous rotation of said elongated fins.

11. The projector according to claim 9, wherein said upper portion of each of said elongated fins has opposite front and rear ends and a pivot hole adjacent to said front end thereof, said connecting rod being disposed above said upper portions of said elongated fins and formed with a plurality of pivot pins extending into said pivot holes in said upper portions of said elongated fins, thereby interconnecting said elongated fins to one another to permit simultaneous rotation of said elongated fins with respect to said front wall of said outer casing.

12. The projector according to claim 9, wherein said connecting rod is formed with a plurality uniformly spaced apart pivot holes, said upper portion of each of said elongated fins further having opposite front and rear ends and an extra pivot pin adjacent to said front end and extending into a respective one of said pivot holes in said connecting rod, thereby interconnecting said elongated fins to one another.

13. The projector according to claim 8, wherein said outer casing has opposite left and right sides, said first opening being disposed adjacent to said left side of said outer casing, said second opening being disposed adjacent to said right side of said outer casing.

14. The projector according to claim 8, wherein each of said upper and lower portions of a respective one of said elongated fins has opposite front and rear ends and an intermediate section between said front and rear ends, said pivot pins being respectively formed on said intermediate sections of said upper and lower portions of said respective one of said elongated fins.

15. The projector according to claim 8, wherein each of said upper and lower portions of a respective one of said elongated fins has opposite front and rear ends, said pivot pins being respectively formed on said upper and lower portions of said respective one of said elongated fins respectively adjacent to said rear ends.
